(19) United States
(12) Patent Application Publication
(10) Pub. No.: US 2023/0229960 A1
(43) Pub. Date: Jul. 20, 2023

(54) SYSTEMS AND METHODS FOR FACILITATING INTEGRATIVE, EXTENSIBLE, COMPOSABLE, AND INTERPRETABLE DEEP LEARNING

(71) Applicant: MICROSOFT TECHNOLOGY LICENSING, LLC, Redmond, WA (US)

(72) Inventors: Chenguang ZHU, Sammamish, WA (US); Lu YUAN, Redmond, WA (US); Yao QIAN, Bellevue, WA (US); Yu SHI, Bellevue, WA (US); Nanshan ZENG, Bellevue, WA (US); Xuedong David HUANG, Yarrow Point, WA (US)

(21) Appl. No.: 17/579,321

(22) Filed: Jan. 19, 2022

(51) Int. Cl. G06N 20/00; G06V 10/774; G10L 15/06; G06F 40/40

(52) U.S. Cl. CPC G06N 20/00; G06V 10/774; G10L 15/063; G06F 40/40

(57) ABSTRACT

Some disclosed systems are configured to obtain a knowledge module configured to receive one or more knowledge inputs corresponding to one or more different modalities and generate a set of knowledge embeddings to be integrated with a set of multi-modal embeddings generated by a multi-modal main model. The systems receive a knowledge input at the knowledge module, identify a knowledge type associated with the knowledge input, and extract a knowledge unit from the knowledge input. The systems select a representation model that corresponds to the knowledge type and select a grounding type configured to ground the at least one knowledge unit into the representation model. The systems then ground the knowledge unit into the representation model according to the grounding type.

### BACKGROUND

In deep learning, there are several different levels of artificial intelligence (AI) including corpus-based, scalable models, multimodality, conversational AI, and social inference. The current status of deep learning mainly focuses on scalable models (i.e., larger models that require more training data). However, these conventional scalable model approaches are limited to statistical learning patterns in a black-box manner. In particular, many conventional scalable models are limited in their ability to access other modalities, conversational AI, and more natural interaction with users in the world.

While large-scale pre-trained models have made some progress in improving accuracy in various perception task, there is still a large gap between the performance of such models and human cognition. For example, current machine learning models rely exceedingly on statistical patterns and struggle to understand deeper level knowledge (e.g., concepts, relations, commonsense, associated with different data and data inputs) which lays the foundation of most intelligent human activity. Additionally, most pre-training solutions treat all input as homogenous. This approach lacks the agility to adopt external information like domain knowledge and personalization during customization. Lastly, most conventional machine learning models are based on data driven black-box models like deep learning, which do not take into consideration control flow driven classic paradigms that humans use during regular cognition tasks.

Additional disadvantages of conventional scalable models include the need to undergo extensive supervised learning. For example, supervised learning requires extensive labeled data. Furthermore, model-free reinforcement learning requires extensive trials and training iterations. For at least these reasons, conventional systems are unable to quickly adapt to new domains, and any changes made to incorporate the knowledge of the new domain(s) requires significant additional training on large training datasets corresponding to the new domain(s).

In view of the foregoing, there is an ongoing need for improved systems and methods for generating and training multi-modal models including the deployment of such models that are configured for dynamic enhancement with knowledge from different domains. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods and devices are provided for facilitating integrative, extensible, composable, and interpretable deep learning. In particular, disclosed embodiments are provided for generating, utilizing, and updating knowledge modules that are used or usable for deep learning applications. Technical benefits are especially apparent with regard to the manner in which the disclosed knowledge modules enable and facilitate processing of multi-modality inputs.

As described herein, disclosed systems are configured to obtain a knowledge module configured to receive one or more knowledge inputs corresponding to one or more different modalities and generate a set of knowledge embeddings to be integrated with a set of multi-modal embeddings generated by a multi-modal main model.

The disclosed systems receive a knowledge input at the knowledge module and identify a knowledge type associated with the knowledge input. The systems also extract a knowledge unit from the knowledge input, the at least one knowledge unit corresponding to the knowledge type. Subsequent to identifying the knowledge types, the systems select a representation model that corresponds to the knowledge type for representing the at least one knowledge unit and select a grounding type configured to ground the at least one knowledge unit into the representation model. The systems also ground the knowledge unit into the representation model according to the selected grounding type.

In some configurations, the knowledge module is dynamically updated with new knowledge comprising the at least one knowledge unit represented in the representation model and based on the knowledge input such that the multi-modal main model is able to learn new knowledge without having to update one or more parameters of the multi-modal main model.

Disclosed systems are also configured for building a multi-modal machine learning model. For example, systems obtain a language model trained to receive text input and generate textual embeddings, obtain an acoustic model trained to receive speech input and generate speech embeddings, obtain a vision model trained to receive image and video input and generate visual embeddings, and obtain a knowledge module trained to receive multi-modal knowledge inputs and generate knowledge embeddings. Such systems are configured to update the knowledge module with new knowledge without having to re-train the language model, acoustic model, or vision model.

Subsequent to obtaining the language model, the vision model, the speech model, and the knowledge module, the systems obtain one or more transformer layers configured to integrate the knowledge embeddings with the textual embeddings, speech embeddings, and visual embeddings. Finally, the systems generate the multi-modal machine learning model by compiling the language model, the acoustic model, the vision model, and knowledge module in parallel. The transformer layers are configured to receive the textual embeddings, speech embeddings, visual embeddings, and knowledge embeddings as input and generate a final set of embeddings comprising a combined output based on integrating the knowledge embeddings into the textual embeddings, speech embeddings, and visual embeddings.

Disclosed systems are also configured to generate a final set of multi-modal embeddings enhanced with knowledge. The systems obtain a multi-modal model comprising (i) a plurality of single-modality models including a language model, an acoustic model, a vision model, (ii) a multi-modality knowledge module, and (iii) a multi-modality transformer, the multi-modal model being configured to integrate knowledge learned by the multi-modality knowledge module with output from the language model, acoustic model, and/or vision model. Such systems are configured to update the multi-modality knowledge module with new knowledge without updating parameters associated with the language model, acoustic model, and vision model.

After obtaining the multi-modal model, the systems receive new input comprising one or more of a following: language modality data, acoustic modality data, or vision modality data. The systems then generate a first set of discretized tokens based on applying language modality data to the language model, a second set of discretized tokens based on applying acoustic modality data to the acoustic model, and a third set of discretized tokens based on applying vision modality data to the vision model. The systems also generate a set of feature vectors based on the first set of discretized tokens, the second set of discretized tokens, and third set of discretized tokens using each of single-modality models.

After generating the set of feature vectors, the systems apply the set of feature vectors to the multi-modality transformer which is configured to perform external attention to intermediate and final outputs of each of the single-modality models. Additionally, the systems identify knowledge units related to the new input and generate a set of knowledge embeddings based on the knowledge units related to the new input. The systems perform cross-attention at one or more layers of the multi-modality transformer to the set of knowledge embeddings in order to integrate the set of knowledge embeddings with the set of feature vectors. Finally, the systems generate the final set of multi-modal embeddings enhanced with knowledge learned from the set of knowledge embeddings integrated with the set of feature vectors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments. The illustrated computing system is configured for optimized speech model and language model generation and machine learning model training and includes hardware storage device(s) and a plurality of machine learning engines. The computing system is in communication with remote/third-party system(s) 120.

FIG. 2 illustrates one embodiment of a multi-modal machine learning model.

FIG. 3 illustrates one embodiment of a process flow diagram for generating a final set of multi-modal embeddings enhanced with knowledge.

FIG. 4 illustrates another example embodiment of a multi-modal machine learning model having a multi-modal main model and a multi-modal knowledge module.

FIG. 5 illustrates an embodiment of a table relating certain knowledge types to different knowledge units, different grounding methods, and different representation models.

FIG. 6 illustrates an embodiment of a process flow diagram for dynamically activating different models and/or rules of a multi-modal machine learning model.

FIG. 7 illustrates an embodiment of a process flow diagram for training a multi-modal machine learning model.

FIG. 8 illustrates an embodiment of an encoder-decoder network associated with a multi-modal machine learning model.

FIG. 9 illustrates an embodiment of a flow diagram having a plurality of acts for updating a multi-modal knowledge module.

FIG. 10 illustrates one embodiment of a flow diagram having a plurality of acts for generating a multi-modal machine learning model.

FIG. 11 illustrates one embodiment of a flow diagram having a plurality of acts for generating a final set of multi-modal embeddings.

### DETAILED DESCRIPTION

Disclosed embodiments are directed towards systems and methods for updating knowledge modules, as well as for generating, training, and instantiating, instantiating or otherwise utilizing a multi-modal machine learning model to generate multi-modal embeddings. In this regard, it will be appreciated that some of the disclosed embodiments are specifically directed to improved systems and methods for generating a final set of multi-modal embeddings that are beneficially configured to be optionally used in various downstream applications.

The disclosed embodiments provide many technical advantages over existing systems, including an integrative, extensible, composable, and interpretable deep learning model, as compared to conventional scalable models or black-box type deep learning models that do not leverage knowledge module, nor are able to process data in a plurality of modalities. Models configured according to disclosed embodiments herein beneficially are configured to understand different modalities, achieve functionalities, and give explanations behind the decision-making process of the model, also while being flexible during customization.

Multi-modal machine learning models that employ external attention to knowledge provide solutions to the aforementioned problems with conventional deep learning models. For example, utilizing knowledge is more efficient than utilizing raw data, particularly when describing principles and patterns. This in turn provides the technical benefit of reducing the amount of needed training data. Additionally, knowledge is essential for humans to easily extrapolate to out-of-distribution scenarios. Similarly, when knowledge is used to enhance multi-modal embeddings, the model is more easily able to adapt to new domains. Furthermore, the knowledge module is configured to be updated without having to re-train the main model on more data.

Knowledge integration further facilitates the ability of the system to scale to large models by learning semantics such as types/subtypes, rules, processes, and commonsense. Thus, systems configured according to the disclosed embodiments allow for the generation of a more compact and smaller model, reducing the cost for training and implementation, and increases learning efficiency of the model. Other technical benefits include bringing in external information, effective customization, and reducing the model size.

For example, knowledge brings external information, which is not available in the task input, but which is helpful to the model when generating the desired output. Additionally, once a model learns how to retrieve and use knowledge during pre-training, the model is configured to quickly adapt to a new or custom domain with previously unseen knowledge. With regard to the term knowledge, it will be appreciated that the term knowledge generally relates to and includes any concepts, relationships, commonsense, other characterization or information extracted from the different knowledge inputs that are received/analyzed. The knowledge inputs comprise any electronic data associated with one or more different modalities (which may be applicable to a particular new domain that the model is being trained for) and in which the electronic data comprises any type of one or more different types and any format of or more different corresponding data formats associated with the different input types.

The adaptations performed by the disclosed models can be even further improved by training the main model with a small amount of additional text, image, and/or speech data associated with a new domain (the new domain being the same domain for which the knowledge input is received). The amount of new domain training data required for performing this enhanced and further tuning or training of the models is much less than would otherwise be required for adapting conventional systems a new domain that do not utilize any knowledge for the specific domain(s) that for which they are trained and optimized.

Disclosed embodiments are directed to systems and methods that facilitate an improvement in deep learning model's decision-making process by increasing transparency and interpretability. For example, by integrating human knowledge, logic, rules and code into a multi-modal machine learning model, the system(s) achieve much better interpretability of the models. This is very important in many Cognitive Services applications such as Decision-based services, where various verticals require the AI system to offer explanations for its decisions.

With knowledge attention, the intensity of external attention to different knowledge units and logic rules can show how much the model's prediction is dependent on specific concepts and rules. It can also highlight the reasoning path within the knowledge graph, which gives human-readable interpretations, which is an improvement over parameter-based large black-box deep learning models.

Another aspect of achieving interpretability is via causal inference, which provides factual and counterfactual analysis for the output, depicting a full picture of the reasoning behind the decision. The causal inference can also quantitatively determine the importance of each factor, offering useful insights for users to adjust their strategy.

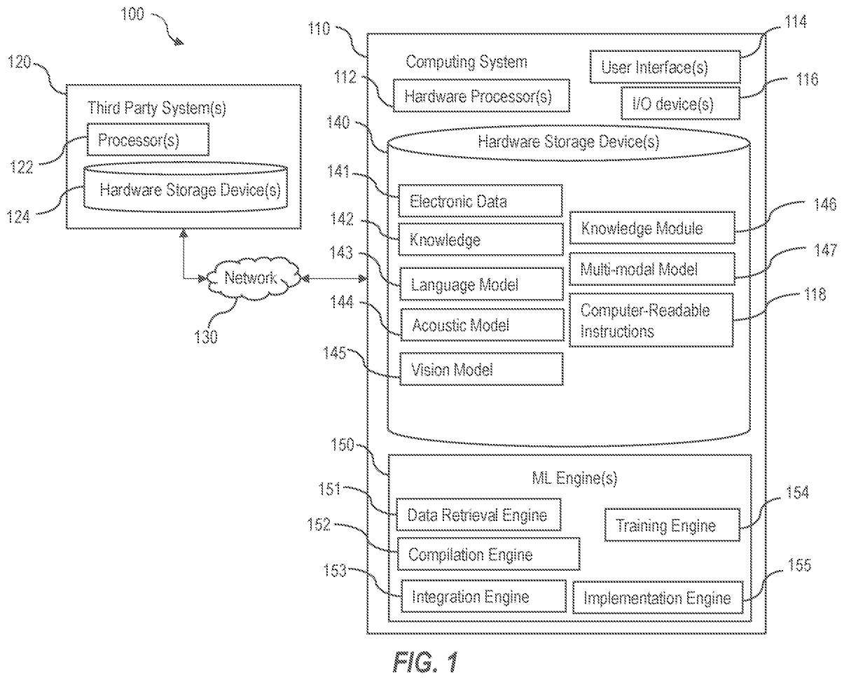

Attention will now be directed to FIG. 1, which illustrates components of a computing system 110 which may include and/or be used to implement aspects of the disclosed invention. As shown, the computing system includes a plurality of machine learning (ML) engines, models, and data types associated with inputs and outputs of the machine learning engines and models.

Attention will be first directed to FIG. 1, which illustrates the computing system 110 as part of a computing environment 100 that also includes remote/third party system(s) 120 in communication (via a network 130) with the computing system 110. The computing system 110 is configured to train and implement a plurality of machine learning models for speech recognition, natural language understanding, text-to-speech (US), image and video recognition, and more particularly, training machine learning models to generate multi-modal embeddings.

The computing system 110, for example, includes one or more processor(s) 112 (such as one or more hardware processor(s)) and a storage (i.e., hardware storage device(s) 140) storing computer-executable instructions 118 wherein one or more of the hardware storage device(s) 140 is able to house any number of data types and any number of computer-executable instructions 118 by which the computing system 110 is configured to implement one or more aspects of the disclosed embodiments when the computer-executable instructions 118 are executed by the one or more processor(s) 112. The computing system 110 is also shown including user interface(s) 114 and input/output (I/O) device(s) 116.

As shown in FIG. 1, hardware storage device(s) 140 is shown as a single storage unit. However, it will be appreciated that the hardware storage device(s) 140 is, in some embodiments, a distributed storage that is distributed to several separate and sometimes remote and/or third-party system(s) 120. The computing system 110 can also comprise a distributed system, in some embodiments, with one or more of the components of computing system 110 being maintained/run by different discrete systems that are remote from each other and that each perform different tasks. In some instances, a plurality of distributed systems performs similar and/or shared tasks for implementing the disclosed functionality, such as in a distributed cloud environment.

The hardware storage device(s) 140 are configured to store the different electronic data 141 and knowledge 142, including various models such as language model 143, acoustic model 144, vision model 145, knowledge module 146, and multi-modal model 147 described herein. The storage (e.g., hardware storage device(s) 140) includes computer-executable instructions 118 for instantiating or executing one or more of the models and/or engines shown in computing system 110. The models are configured as machine learning models or machine learned models, such as deep learning models and/or algorithms. In some instances, the one or more models are configured as engines or processing systems (e.g., computing systems integrated within computing system 110), wherein each engine (i.e., model) comprises one or more processors (e.g., hardware processor(s) 112) and computer-executable instructions 118 corresponding to the computing system 110.

The electronic data 141 comprises data from a plurality of different modality sources, including acoustic data (e.g., sounds, background noises, spoken language utterances, synthesized language utterances, pronunciations of words), textual data (e.g., unstructured text, structured text, annotated text, unannotated text, dictionaries, and visual data (e.g., images, videos). The electronic data 141 also comprises data associated with different knowledge types, such as knowledge graphs and knowledge bases, and comprises rule-based data (e.g., rules or pieces of rules). When the electronic data 141 is applied to the main model of the multi-modal machine learning model, it is referred to as main model input, input, and/or new input. When the electronic data 141 is applied to the knowledge module of the multi-modal machine learning model, it is referred to as knowledge input.

The knowledge module receives the knowledge input comprising a sub-set of the electronic data and processes the knowledge input to generate a set of knowledge embeddings. The knowledge input is analyzed, wherein the knowledge module identifies a knowledge type associated with the knowledge input (i.e., determines whether the knowledge input in the form of a knowledge graph, a knowledge base, unstructured text, dictionary, data, rules, image, and/or sounds). Additionally, the knowledge module identifies a particular type of knowledge unit associated with the knowledge type, a representation model configured to represent knowledge according to the knowledge type, and a grounding method configured to ground the particular type of knowledge unit into the representation model.

The referenced knowledge 142 generally describes the information that the knowledge module has learned and stores within the different representation models, and the information that is used to enhance the embeddings from one or more of the acoustic model, language model, or vision model of the main model. In particular, knowledge comprises a plurality of knowledge units that have been extracted from different knowledge inputs. When external attention is applied between the main model and knowledge module, the knowledge module is able to enhance the embeddings from the main model with knowledge that is has previously learned/stored. If the knowledge module determines that no previously stored knowledge is related to the input of the main model, the knowledge module is configured, in some instances, to retrieve new knowledge inputs that are related to the main model input in order to extract a new set of knowledge units.

Acoustic data comprises electronic content/data obtained from a speaker or a source comprising one or more speakers or a source comprising one or more speakers, background noise, non-human speakers and/or machine speakers. In some instances, the acoustic data comprise(s) audio data and/or audio-visual data. Additionally, or alternatively, the acoustic data comprise metadata (i.e., attributes, information, speaker identifiers, etc.) corresponding to the particular source from which the data is collected. In some embodiments, the metadata comprises attributes associated with the identity of the speaker, characteristics of the acoustic data and/or a speaker's voice and/or information about where, when and/or how the acoustic data is obtained.

In some embodiments, the acoustic data is raw data, wherein the acoustic data is recorded in real time from a target speaker, or a set of target speakers. The acoustic data comprises processed data (e.g., waveform format of the audio data corresponding to one or more target speaker or comprising natural language data). For example, speech data (i.e., audio data) is extracted from previously recorded audio files and/or video files such as speech recognized by speech recognition models. In such instances, speech recognition models collect and store speech data from a speaker through authorized third-party applications, such as personal assistant devices, auditory search queries, recorded audio messages, and general conversation recognized by the speech recognition model.

This data can be aggregated over time for a specific application, across many applications, for a specific device, and/or across all of the user's devices. In some embodiments, applications include web, mobile, and/or desktop applications. The referenced devices comprise speech-enabled devices such as, but not limited to, personal assistant devices, audio-enabled speakers, mobile phones, smart devices, internet-of-things (IoT) devices, laptops, and/or any device capable of listening, recognizing, and recording natural speech data from particular and/or multiple speakers.

Textual data comprises electronic content/data obtained from one or more sources comprising text-based natural language utterances. The textual data comprise(s) text data and/or visual data including images comprising textual data and/or transcription data. The textual data also comprises metadata (i.e., attributes, information, speaker identifiers, etc.) corresponding to the particular source from which the data is collected. The metadata/attributes reflect and/or are usable to identify the identity of a speaker from which the text data is transcribed, characteristics of the textual data and/or information about where, when and/or how the textual data is obtained.

In some embodiments, a computing system has access to a plurality of different applications such as word processing, email, document creation, document consumption, proof reading, wherein the computing system is able to extract text content from these applications and/or read text aloud to capture TTS data via the neural TTS model. The textual data are computer generated text from a language model or natural language generator. In some instances, the textual data are extracted from third party sources such as newspapers, articles, books, and/or other public sources. In some instances, the textual data are authored by a particular user. In some instances, the textual data are extracted from within a particular application and/or content associated with a particular application, such as a media slideshow application, an email application, a calendar application, a document creator, a spreadsheet application, etc.

Visual data comprises image data and/or video data, including visual data extracted from audio-visual data or optical text recognition. In some embodiments, the acoustic data, textual data, and/or visual data is collected and stored as part of a usage log. The usage log collects speech data from a single application. The user authorizes the usage log stores data from multiple sources and/or applications. For example, a user is able to authorize the storage and use of data collected from a virtual personal assistant application such as Cortana. In such instances, the user speaks to the virtual personal assistant to do web searches, email searches, send text messages, send emails, and other speech-enabled queries and actions. As the user continues to use virtual assistant, more and more speech data is collected and added into the usage log. This data can then be used as training data to train a speech model, language model, or vision model.

The hardware storage device(s) 140 is also configured to store a language model 143, an acoustic model 144, a vision model 145, and a knowledge module 146, which make up the multi-modal model 147. The electronic data 141 including acoustic data, textual data, and visual data is sometimes formatted as training data, wherein the acoustic model 144, language model 143 and/or vision model 145 is trained (or pre-trained) on the training data.

An additional storage unit for storing machine learning (ML) Engine(s) 150 is presently shown in FIG. 1 as storing a plurality of machine learning models and/or engines. For example, computing system 110 comprises one or more of the following: a data retrieval engine 151, a compilation engine 152, an integration engine 153, a training engine 154, and an implementation engine 155, which are individually and/or collectively configured to implement the different functionality described herein.

For example, the data retrieval engine 151 is configured to locate and access data sources, databases, and/or storage devices comprising one or more data types from which the data retrieval engine 151 can extract sets or subsets of data to be used as training data. The data retrieval engine 151 receives data from the databases and/or hardware storage devices, wherein the data retrieval engine 151 is configured to reformat or otherwise augment the received data to be used as training data. Additionally, or alternatively, the data retrieval engine 151 is in communication with one or more remote/third-party systems (e.g., remote/third party system(s) 120) comprising remote/third party datasets and/or data sources. In some instances, these data sources comprise audiovisual services that record speech, text, images, and/or video.

The data retrieval engine 151 accesses electronic content comprising acoustic data, textual data, and/or other types of audio-visual data including video data, image data, holographic data, 3-D image data, etc. The data retrieval engine 151 is a smart engine that is able to learn optimal dataset extraction processes to provide a sufficient amount of data in a timely manner as well as retrieve data that is most applicable to the desired applications for which the machine learning models/engines will be trained. For example, the data retrieval engine 151 can learn which databases and/or datasets will generate training data that will train a model (e.g., for a specific query or specific task) to increase accuracy, efficiency, and efficacy of that model in the desired natural language understanding application.

The data retrieval engine 151 locates, selects, and/or stores raw recorded source data (e.g., natural speech data), wherein the data retrieval engine 151 is in communication with one or more other ML engine(s) and/or models included in computing system 110. In such instances, the other engines in communication with the data retrieval engine 151 are able to receive data that has been retrieved (i.e., extracted, pulled, etc.) from one or more data sources such that the received data is further augmented and/or applied to downstream processes.

The computing system 110 includes a compilation engine 152 that is configured to compile one or more machine learning models to generate an optimized or integrated multi-modal machine model. The compilation engine 152 is configured to compile a knowledge module 146, with one or more of a language model 143, acoustic model 144, and/or vision model in order to generate a multi-modal model 147. The foregoing compilation of models is used for building an optimized multi-modal model which leverages both acoustic and contextual natural language understanding, along with vision understanding and knowledge integration.

The integration engine 153 is configured to integrate knowledge that has been grounded in the knowledge module 146, wherein the knowledge can be leveraged during data processing to enhance the multi-modal embeddings. The training engine 154 is configured to pre-train or train the multi-modal model 147, the acoustic model 144, the language model 143, the vision model 145 and/or the knowledge module 146.

The training engine 154 is configured to train the multi-modal machine learning model to process data in one or more different modalities according to different tasks and use knowledge to enhance the final output of the multi-modal machine learning module. In addition, the training engine is configured train a speech/acoustic model of the multi-modal machine learning model to detect and understand spoken language, an language/text model of the multi-modal machine learning model to detect and understand text-based language and perform semantic analysis, a vision model of the multi-modal machine learning module to detect and identify objects within image-based data, and/or a knowledge module of the multi-modal machine learning model to extract knowledge units from different knowledge inputs and generate knowledge embeddings.

It will be appreciated that the term “train”, as used herein, refers to training, pre-training, and/or post-training a machine learning or machine learned model and that the terms “training,” “pre-training” and “post-training” can be viewed as interchangeable. Training typically refers to the process of configuring a model for a particular task, by applying training data to the model being trained. The process of training a model is a sequential process that involves exposing the machine learning model to different training data while confirming or rejecting characterizations of the training data. In terms of sequential training operations, pre-training occurs prior to training and training occurs prior to post-training.

During each sequential phase of training, the model may be exposed to new and different training data. In some embodiments, a model is “pre-trained” before a further training operation, such as joint training with another model or integration with another model. The terms associated with training a model may also refer to the processes of adapting, tuning, optimizing and/or otherwise modifying a model that has already undergone at least some training, by further integrating the model with another model and/or by joint training the model with interdependent training data from another model.

In some embodiments, the computing system 110 includes an implementation engine 155 in communication with any one of the models and/or ML engine(s) 150 (or all of the models/engines) included in the computing system 110 such that the implementation engine 155 is configured to implement, initiate, or run one or more functions of the plurality of ML engine(s) 150. In one example, the implementation engine 155 is configured to operate the data retrieval engines 151 so that the data retrieval engine 151 retrieves data at the appropriate time to be able to generate training data for the training engine 154. The implementation engine 155 facilitates the process communication and timing of communication between one or more of the ML engine(s) 150.

The computing system is in communication with remote/third party system(s) 120 comprising one or more processor(s) 122 and one or more computer-executable instruction(s) 124. It is anticipated that, in some instances, the remote/third party system(s) 120 further comprise databases housing data that could be used as training data, for example, external speaker data. Additionally, or alternatively, the remote/third party system(s) 120 include machine learning systems external to the computing system 110. In some embodiments, the remote/third party system(s) 120 are software programs or applications.

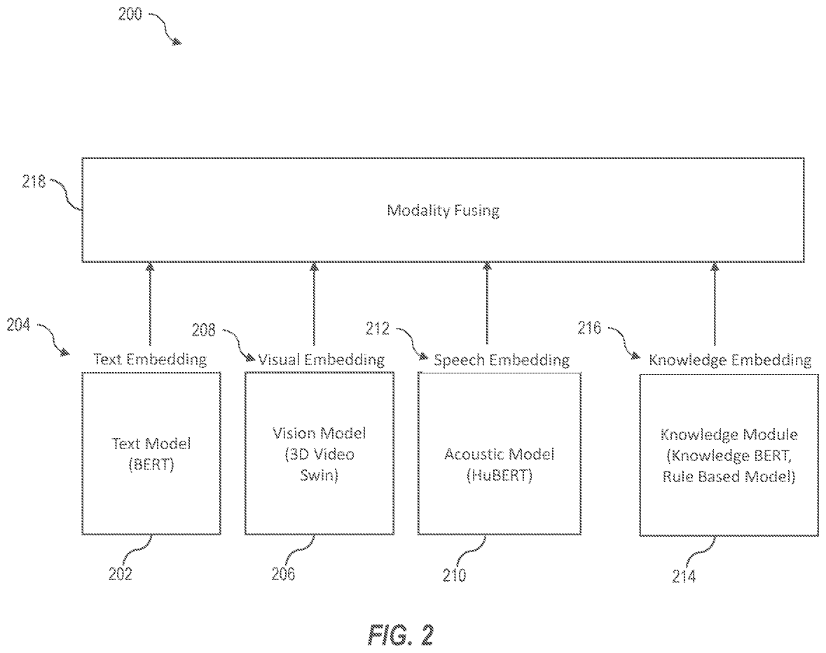

Attention will now be directed to FIG. 2, which illustrates one embodiment of a multi-modal machine learning model. To better understand semantic information, the disclosed embodiments provide for a shared architecture across different modalities, with integration of knowledge, rules, other model's outputs, and other external information. This information is transmitted to a shared Transformer (e.g., modality fusing layer 218) for processing. By configuring a multi-modal model in this manner, many technical benefits are achieved including facilitating an efficient way to leverage progress from state-of-the-art single modality models via their contextualized inputs. The multi-modal machine learning model 200 is beneficially configured to perform inner-modality attention and inter-modality attention to facilitate an improvement in learning from different modality signals.

In certain modality fusing layers, the signals from one modality (e.g., text) are configured to attend to signals from the same modality. In other modality fusing layers, the signals from any modality are configured to attend to other signals from any modality. These two types of layers are constructed alternatingly within the modality fusing layer 218. In this manner, inner-modality attention leads to an improvement in the quality of understanding of a single modality, while inter-modality attention facilitates an improvement in understanding information from other modalities.

As illustrated in FIG. 2, a multi-modal machine learning model 200 is shown having a text-based machine learning model 202 (e.g., “BERT”), a visual-based machine learning model 206 (“3D Video Swin”), a speech-based machine learning model 210 (e.g., “HuBERT”), and a knowledge module 214 (e.g., “Knowledge BERT”, “Rule Based Model”). The text-based machine learning model 202 is configured to receive text-based input or input that comprises at least some text-based data that can be extracted and converted to text embeddings 204. The visual-based machine learning model 206 is configured to receive visual-based input (e.g., image and/or video data) or input that comprises at least some image and/or video data that can be extracted and converted to visual embeddings 208. The speech-based machine learning model 210 is configured to receive speech-based input or input that comprises at least some audio data that can be extracted and converted to generate speech embeddings 212.

The knowledge module 214 is configured to receive input in a variety of modalities (e.g., text, visual, and/or audio), from a variety of different knowledge types, and to convert the knowledge units extracted from the knowledge input into knowledge embeddings 216. The text embeddings 204, visual embeddings 208, speech embeddings 212, and knowledge embeddings 216 are applied as input to a modality fusing layer 218 of the machine learning model, which fuses the different embeddings together in order to generate a final set of embeddings that is enhanced by the knowledge learned by the knowledge module 214. In some instances, each of the different types of embeddings are encoded to a shared representational space prior to being applied to the modality fusing layer 218.

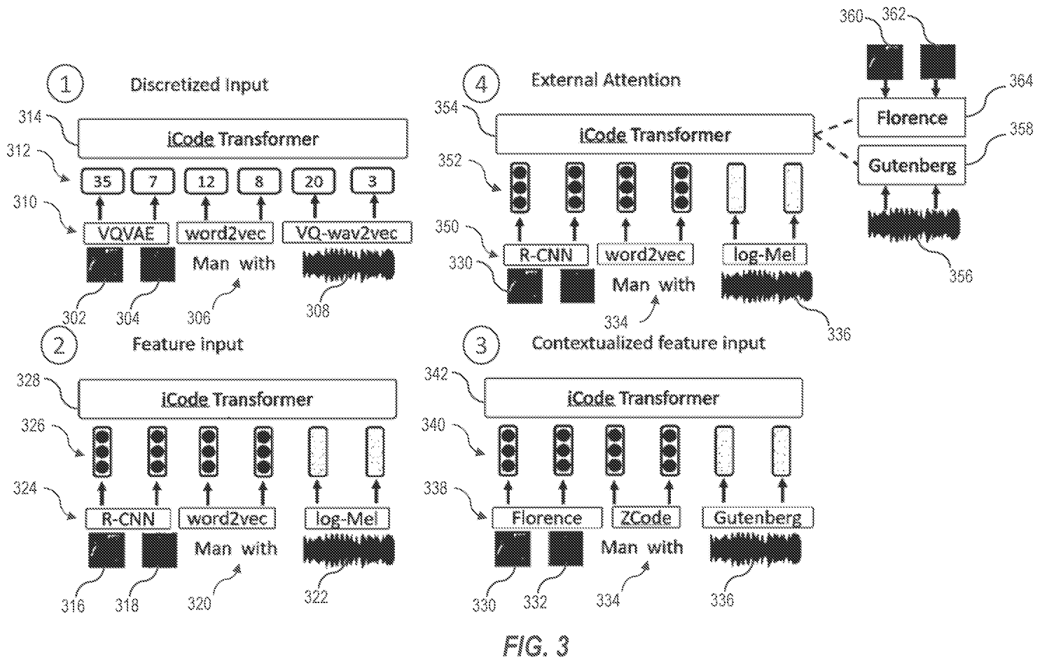

Attention will now be directed to FIG. 3, which illustrates one embodiment of a process flow diagram for generating a final set of multi-modal embeddings enhanced with knowledge. As shown in FIG. 3, four phases of the multi-modal model architecture are illustrated. In Phase 1, the systems are configured to discretize input tokens. In other words, the inputs associated with each of the modalities, such as vision input 302 (e.g., photograph or other image), vision input 304 (e.g., video data), text input 306 (e.g., “Man with”), and speech input 308 (e.g., audio data comprising spoken language utterances) are discretized into tokens (e.g., tokens 312) from vocabulary, using a plurality of discretizers 310 (e.g., VQ-VAE for vision, word2vec for text, and VQ-wav2vec for speech). The tokens 312 are then applied to the iCode Transformer 314 which is configured as a modality fusing layer (e.g., modality fusing layer 218 of FIG. 2).

In Phase 2, the feature vector inputs (e.g., feature-based vectors 326) are generated by low-level encoders 324 (e.g., R-CNN for vision input 316 and vision input 318, word2vec for text input 320, and log-Mel for speech input 322). The feature-based vectors 326 are applied as input to the transformer layer 328. In Phase 3, the feature vector input is generated by state-of-the-art single modality models. For example, a plurality of inputs is applied to different single-modality models 338 based on which input is associated with the particular modality of the single-modality model. As illustrated, vision input 330 and vision input 332 (or the corresponding feature-based vectors 326) are applied as input to a single modality model for vision (e.g., Florence). Text input 334 (e.g., “Man with”) is applied as input to a single modality model for text (e.g., “ZCode”). Speech input 336 is applied to a single modality model for speech (e.g., “Gutenberg”). Each of the single modality models 338 are configured to generate contextualized feature inputs based on the different inputs (and/or based on the previous set of feature-based vectors 326). These contextualized feature inputs 340 are fed into the iCode Transformer 342.

Finally, in Phase 4, external attention is performed to intermediate and final output of single-modality models. For example, the model conducts external attention in all layers of the iCode Transformer 354 to generate intermediate and final output for each of the single-modality models. For example, a plurality of inputs (e.g., vision input 330, text input 334, and speech input 336) are applied to a plurality of models 350 associated with the different modalities (e.g., R-CNN for vision, word2vec for text, and log-Mel for speech), wherein the inputs are converted to different sets of embeddings 352 using the iCode Transformer 354.

Meanwhile, appropriate grounding techniques are used to retrieve related knowledge from external information sources like text corpus 360, image corpus 362, and/or audio corpus 356. Related knowledge input is converted to knowledge embeddings using one or more models such as a vision-based knowledge model (e.g., Florence 364) or a speech-based knowledge model (e.g., Gutenberg 358). In this manner, when the final set of embeddings are generated, they are enhanced with knowledge learned from the information extracted from the external information sources.

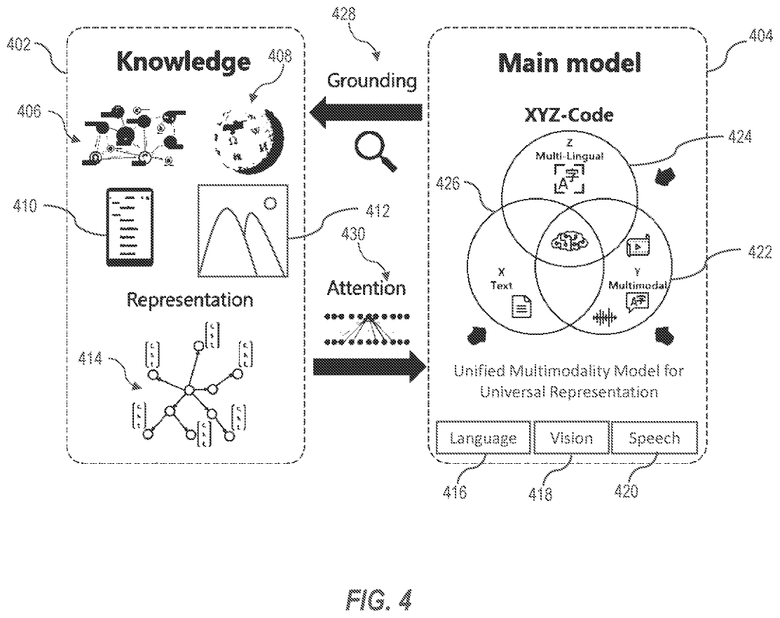

Attention will now be directed to FIG. 4, which illustrates another example embodiment of a multi-modal machine learning model having a multi-modal main model and a multi-modal knowledge module. As illustrated in FIG. 4, a multi-modal main model 404 is shown having a plurality of single-modality models (e.g., language model 416, vision model 418, and speech model 420). the multi-modal main model 404 is configured as a unified multimodality model for universal representation of inputs associated with the different modalities. The multi-modal main model 404 also has XYZ-code capability (e.g., X being representative of text capability 426, Y being representative of multi-modal capability 422, and Z being representative of multi-lingual capability 424).

FIG. 4 also illustrates a knowledge module 402 which is configured to learn knowledge information from different external sources (e.g., wherein different external sources comprise data in different modalities of corresponding/underlying inputs) associated with different modalities (e.g., knowledge graphs 406, language databases 408, text-based sources 410, image-based sources 412). The knowledge module 402 is configured to represent all knowledge information learned as knowledge units in one or more representations (e.g., a graph neural network 414). The knowledge module 402 is configured to a composable part of the multi-modal model (e.g., iCode architecture). The knowledge module 402 is configured to smoothly integrate into existing iCode architecture (and/or existing main model 404) and work with different modalities of data. The disclosed embodiments are directed to systems and methods for grounding knowledge, representing knowledge, and fusing knowledge back into the main model.

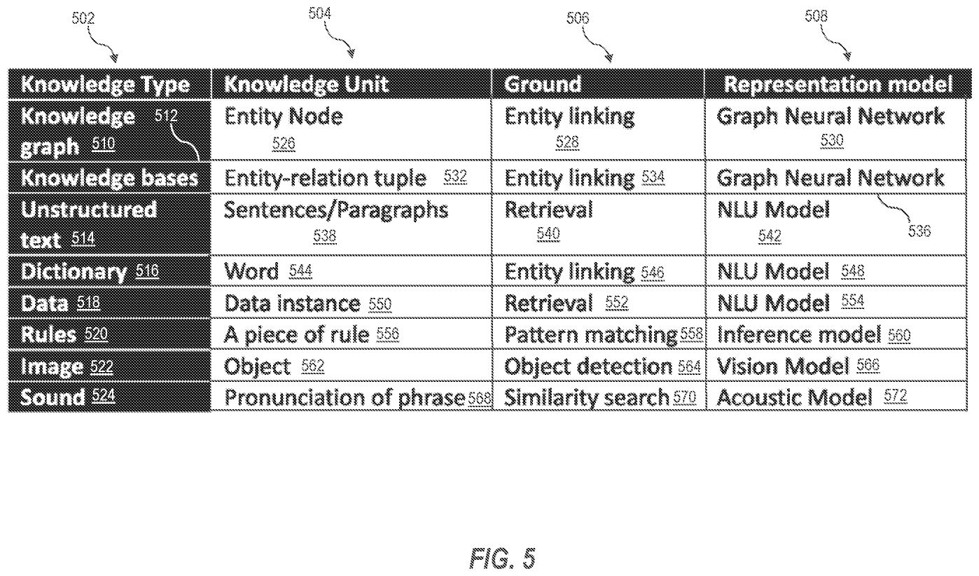

For example, the knowledge module 402 is configured to ground information with possible external associations in the input (e.g., NER/entity linking to get entities in the textual input that correspond to knowledge graph nodes, see FIG. 5). For visual input, the knowledge module 402 is configured to use an object detection module to get object names which can then be mapped into entities. For speech input, the knowledge module 402 is configured to use automatic speech recognition systems to convert input audio signals into text for knowledge grounding. In some instances, the knowledge module 402 is configured to get knowledge by leveraging existing large models (e.g., GPT-3, T5) to generate related knowledge information based on the input.

The knowledge module 402 is also configured to represent the knowledge to incorporate both context and the knowledge structure (e.g., using a graph neural network to produce node embeddings for each entity based on its meaning and relation to other entities. This includes multi-step reasoning to conduct inference according to knowledge structures. Additionally, the knowledge module 402 is configured to integrate external information via attention into the main model 404 (e.g., selectively leveraging the retrieved information according to its relatedness to the input and the task). This step ensures that the knowledge information from knowledge inputs will be effectively leveraged in the cognition task.

The main model 404 is configured to use knowledge from the knowledge module 402 by performing external attention 430 to the one or more knowledge representations. Additionally, the knowledge module 402 is able to learn new knowledge by extracting knowledge learned from the main model 404, wherein the new knowledge is grounded to the knowledge module via different grounding techniques 428.

Attention will now be directed to FIG. 5, which illustrates an embodiment of a table relating certain knowledge types 502 to different knowledge units 504, different grounding methods 506, and different representation models 508. Different knowledge types 502 include knowledge graphs 510, knowledge bases 512, unstructured text 514, dictionaries 516, data 518, rules 520, images 522, and/or sounds 524. To accommodate different knowledge types and different modalities, a “knowledge unit” is defined as the unified term for information to integrate. Knowledge from different sources is broken down to a semantic unit (e.g., knowledge unit) to be grounded. Then, different representation models are configured to convert knowledge units into embeddings (one per unit) for the main model (e.g., multi-modal main model 404 of FIG. 4) to attend and integrate.

The knowledge type 502 for knowledge graphs 510 corresponds to the knowledge unit 504 for an entity node 526, a grounding method 506 for entity linking 528, and a representation model 508 for a graph neural network 530. Entity linking is configured to ground concepts in the knowledge information input into certain nodes in the knowledge graph 510. The system(s) then use a graph neural network 530 to represent the knowledge graph 510 and return the embeddings. The knowledge type 502 for knowledge bases 512 corresponds to the knowledge unit for an entity-relation tuple 532, a grounding method 506 for entity linking 534, and a representation model 508 for a graph neural network 536.

The knowledge type 502 for unstructured text 514 corresponds to the knowledge unit 504 for sentences/paragraphs 538, a grounding method 506 for retrieval 540, and a representation model 508 for a natural language understanding model 542. The knowledge type 502 for dictionaries 516 corresponds to the knowledge unit 504 for a word 544, a grounding method 506 for entity linking 546, and a representation model 508 for a natural language understanding model 548.

The knowledge type 502 for data 518 corresponds to the knowledge unit 504 for a data instance 550, a grounding method 506 for retrieval 552, and a representation model 508 for a natural language understanding model 554. The knowledge type 502 for rules 520 corresponds to the knowledge unit 504 for a piece of rule 556, a grounding method 506 for pattern matching 558, and a representation model 508 for an inference model 560.

The knowledge type 502 for images 522 corresponds to the knowledge unit 504 for an object 562, a grounding method 506 for object detection 564, and a representation model 508 for a vision model 566. The knowledge type 502 for sounds 524 corresponds to the knowledge unit 504 for a pronunciation of word/phrase 568, a grounding method 506 for similarity search 570, and a representation model 508 for an acoustic model 572.

One disadvantage of conventional data driven deep learning models is that their framework does not encompass explainable rules and control flow which are often used in human intelligence. Although some conventional approaches employ “soft logic” to approximately parameterize rules, the inherent “hard logic” and control is inevitably lost, and only emerges as part of the black box learning associated with conventional deep learning models. Thus, the disclosed systems and methods improve upon conventional deep learning models by explicitly leveraging rules and control flow in order to combine the merits from the data driven models and logical rules.

In some instances, the disclosed embodiments are directed to a result-based integration. While data driven models and rules have drastically different representations of computational logic, each model/rule produces predictions in the same space, wherein the predictions can then be ensembled. For example, in a regression task, some disclosed systems are configured to compute instance-specific weights to combine the predicted variable from several data driven models and multiple rule-based systems. The weights are calculated based on the confidence of the model, the input characteristics, and previously generated feedbacks to the system.

In another example, the disclosed embodiments are directed to an efficient and trainable way to ensemble multiple learning systems (e.g., mixture of experts). In a mixture of experts configuration, the system (e.g., a controller) decides based on the input 616 which models to activate for the prediction. The system uses rules 606 as the controller to integrate the rule system as part of the model pools. The difference between the mixture of experts configuration and result-based integration is that the mixture of experts determines model selection at the input phase, instead of combining results after all models are used to generate intermediate embeddings. Furthermore, a sparse selection of models can be coupled with a very large pools of models to improve efficiency. It should be appreciated that the systems and methods are configurable according to the mixture of experts configuration, the result-based integration, or a combination of both configurations.

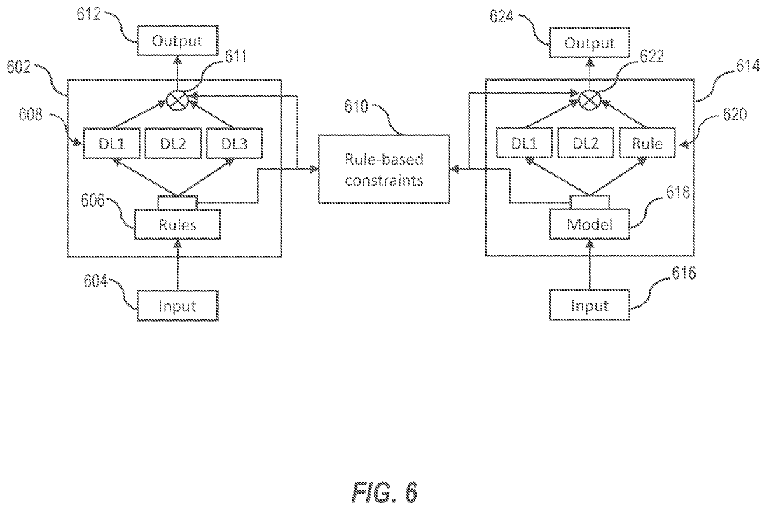

Attention will now be directed to FIG. 6, which illustrates an embodiment of a process flow diagram for dynamically activating different models and/or rules of a multi-modal machine learning model according to a mixture of experts configuration described above. For example, input 604 is applied to rule-based model 602, wherein one or more rules 606 are identified which are most relevant to the input 604. Based on the identified rules, the input is applied to a select one or more models 608 (e.g., DL1 and DL3) which are configured to generate embeddings based on the input 604. The rule-based model 602 is configured to integrate the different embeddings (e.g., integration 611) in order to generate the final output 612.

The identified rules 606 are shared in a rule-based constraints cache 610 between the rule-based model and the additional model 614. As illustrated, input 616 is applied to the additional model 614 which also shares information with the rules-based constraints cache 610. The model 618 is configured to activate one or more different models or rules 620, which in turn are configured to generate embeddings based on the input 616. The embeddings are combined (e.g., integration 622) based on the output from the different models are rules 620 and information from the rules-based constraints cache 610 in order to generate a final output 624.

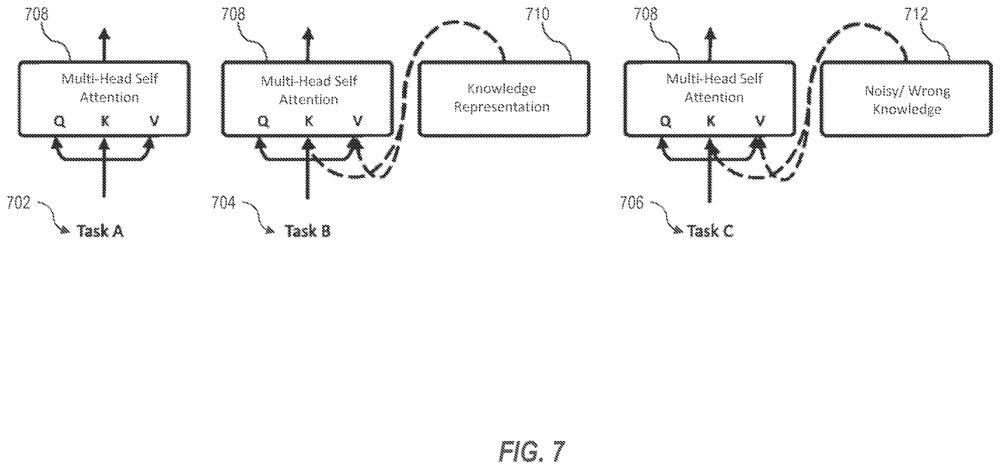

Attention will now be directed to FIG. 7, which illustrates an embodiment of a process flow diagram for training a multi-modal machine learning model. FIG. 7 illustrates a training regime for knowledge-empowered contrastive representation learning. Besides rule and control flow, the disclosed embodiments are also directed to contrastive learning which is configured to encourage the pre-trained representation to leverage external knowledge when it is available and immune to wrong information when the knowledge is imprecise or noisy. More specifically, the disclosed embodiments are directed to three different training tasks. For example, Task A 702 is a normal representation learning task without using any external knowledge. It ensures that the learned representation (e.g., multi-head self-attention module 708) can independently perform desired tasks (e.g., generation of embeddings) when external knowledge is unavailable.

Task B 704 extends the multi-head self-attention module 708 to additionally utilize external knowledge (e.g., knowledge representation 710). Task B 704 training encourages the learned representation to be knowledge-friendly and capable of achieving better performance. Task C 706 s similar to Task B 704, wherein the multi-head self-attention module 708 is extended to additionally utilize external knowledge. However, in Task C, the knowledge 712 is wrong and/or noisy. In this manner, the system is trained to be immune to wrong knowledge (e.g., the system learns to identify wrong knowledge or knowledge that is not related to the input and ignore the knowledge presented during the external attention phase). Additionally, or alternatively, the system learns to distinguish between relevant knowledge from among the noisy knowledge that also includes wrong knowledge and learns to apply only the relevant knowledge during the external attention phase.

In the contrastive learning setting, the system(s) are configured such that Task A 702 performs sufficiently well when external knowledge is unavailable (i.e., embedding generating is not hindered when the external attention phase returns no knowledge). Additionally, the system(s) are configured such that Task B 704, with external knowledge, performs better than Task A 702 (i.e., the embeddings are enhanced with relevant knowledge gleaned from the external attention phase). Lastly, Task A 702 performs better than Task C 706, with noisy or incorrect knowledge.

In both Task B 704 and Task C 706, the knowledge representation is assumed to be separately learned, thus beneficially configuring the system(s) to directly plug into the inference stage without changing the pre-trained representation (e.g., pre-trained multi-head self-attention module). In other words, because the knowledge is learned separately, the multi-modal main model does not need to be constantly updated, even when the knowledge module is updated with new knowledge.

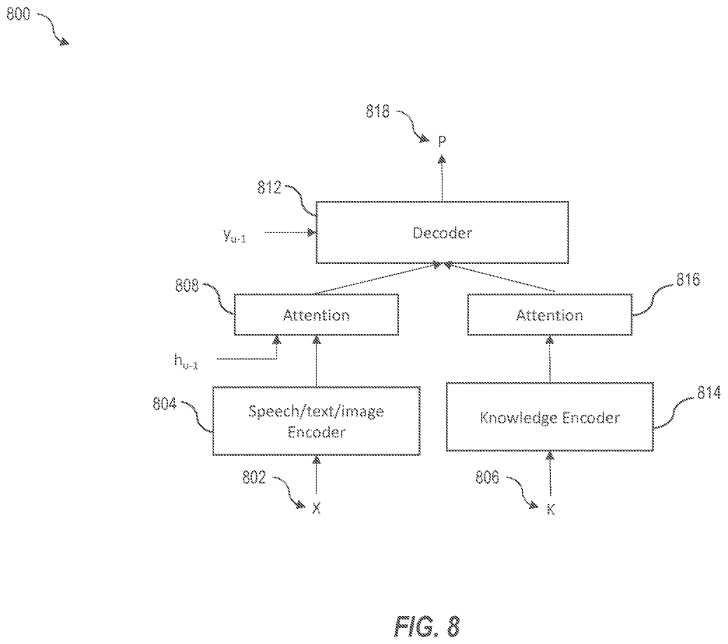

Attention will now be directed to FIG. 8, which illustrates an embodiment of an encoder-decoder network (e.g., deliberation network) associated with a multi-modal machine learning model. The deliberation network 800 is configured to be used in various downstream tasks such as machine translation, speech recognition, audio/visual-to-text or speech-to-text translation. The deliberation network 800 utilizes a combined encoder 804 (e.g., speech/text/image encoder) and a decoder 812, in addition to a second pass decoding.

Multi-modal input 802 (e.g., “X”) is input to the combined encoder 804, which then passes through an attention layer 808 before being applied as input to the decoder 812. The deliberation network 800 is also shown having a knowledge encoder 814 which receives knowledge input 806 (e.g., “K”), passes through an attention layer 816 and is received by the decoder 812. The decoder 812 is configured to “express” the results of deliberation of the various inputs and generate a prediction of combined embeddings 818 (e.g., “P”). Deliberation refers to the process when a human uses their knowledge to understand what is received and express their responses. In similar manner, the deliberation network 800 imitates this process for knowledge integration which is illustrated in FIG. 8.

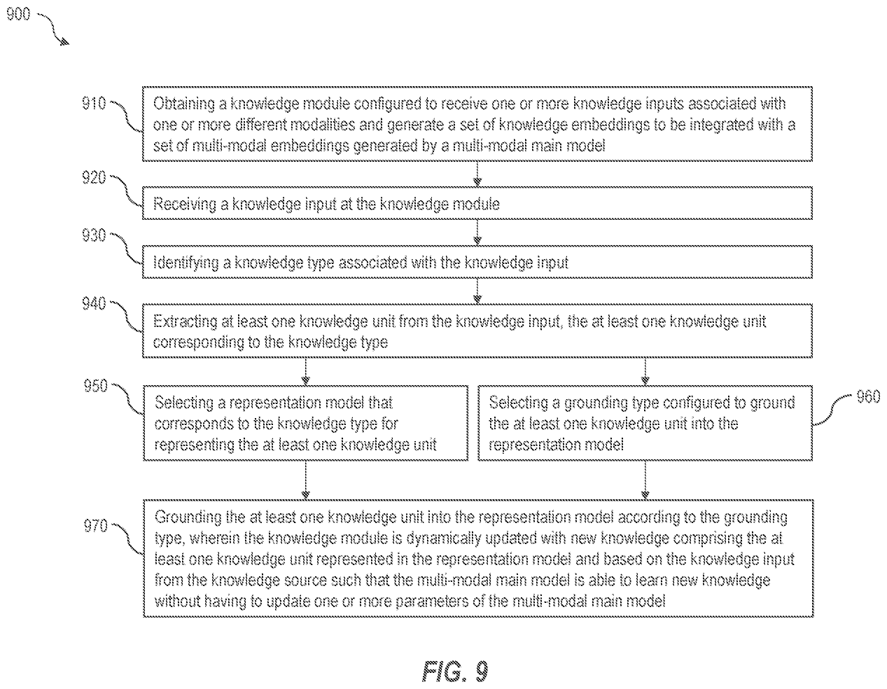

Attention will now be directed to FIG. 9 which illustrates a flow diagram 900 that includes various acts (act 910, act 920, act 930, act 940, act 950, act 960, and act 970) associated with exemplary methods that can be implemented by computing system 110 for updating a knowledge module.

The first illustrated act includes an act of obtaining a knowledge module configured to receive one or more knowledge inputs associated with one or more different modalities and generate a set of knowledge embeddings to be integrated with a set of multi-modal embeddings generated by a multi-modal main model (act 910). The systems receive a knowledge input at the knowledge module (act 920) and identify a knowledge type associated with the knowledge input (act 930). The systems also extract at least one knowledge unit from the knowledge input, the at least one knowledge unit corresponding to the knowledge type (act 940).

Subsequent to identifying the knowledge types, the systems select a representation model that corresponds to the knowledge type for representing the at least one knowledge unit (act 950) and select a grounding type configured to ground the at least one knowledge unit into the representation model (act 960).

The performance of the foregoing acts, which are more fully described throughout this disclosure, facilitate a technical benefit of applying external information which is not available in the task input but is helpful to the model when generating output that is relevant to a particular domain for which the external information is received. Additionally, once a model learns how to retrieve and use knowledge during pre-training, the model is configured to quickly adapt to a new or custom domain with previously unseen knowledge. This adaptation is further improved with a small amount of text, image, and/or speech data associated with the new domain. The amount of new domain data is much less when using knowledge than the amount required to sufficiently customize the entire main model.

As also shown in FIG. 9, the systems further ground or lock the knowledge unit into the representation model according to the grounding type (act 970). In some configurations, the knowledge module is dynamically updated with new knowledge comprising the at least one knowledge unit represented in the representation model and based on the knowledge input such that the multi-modal main model is able to learn new knowledge without having to update one or more parameters of the multi-modal main model.

By configuring systems in this manner, many technical benefits are realized, including an integrative, extensible, composable, and interpretable deep learning model. Models configured according to disclosed embodiments herein beneficially are configured to understand different modalities, achieve functionalities, and give explanations behind the decision-making process of the model, also while being flexible during customization. Multi-modal machine learning models that employ external attention to knowledge provide solutions to the aforementioned problems with conventional deep learning models. For example, utilizing knowledge is more efficient than utilizing raw data, particularly when describing principles and patterns. This in turn provides the technical benefit of reducing the amount of needed training data. Additionally, knowledge is essential for humans to easily extrapolate to out-of-distribution scenarios. Similarly, when knowledge is used to enhance multi-modal embeddings, the model is more easily able to adapt to new domains. Furthermore, the knowledge module is configured to be updated without having to re-train the main model on more data.

The systems are configured to distinguish between and selectively identify many different knowledge types, different knowledge units, different grounding types, and different representation models. For example, in some instances, the knowledge type is identified from one or more of a following knowledge types: knowledge graph, knowledge base, unstructured text, dictionary, data, rule, image, or sound. The knowledge unit is identified from one or more of a following knowledge units: entity node, entity-relation tuple, sentences/paragraphs, words, data instance, a piece of rule, object, or pronunciation of phrase. The grounding type is selected from one or more of a following knowledge units: entity linking, retrieval, pattern matching, object detection, or similarity search. The representation model is selected from one or more of a following representation models: graph neural network, natural language understanding model, inference model, vision model, or acoustic model.

Additionally, the systems are beneficially configured to utilize knowledge that is received from input associated with different knowledge modalities. For example, the knowledge module comprises at least one representation model configured to generate knowledge embeddings from speech-based knowledge inputs, at least one representation model configured to knowledge embeddings from visual-based knowledge inputs, and at least one representation model configured to generate knowledge embeddings from text-based knowledge inputs.

During run-time, the systems implement the knowledge module in order to generate one or more knowledge embeddings based on applying the knowledge input to the representation model, wherein the representation model is configured to convert the at least one knowledge unit into at least one knowledge embedding.

Subsequent to generating the one or more knowledge embeddings, the systems are also configured to integrate the knowledge embeddings with multi-modal embeddings. For example, the systems integrate the one or more knowledge embeddings with one or more multi-modal embeddings obtained from the multi-modal main model and generate a final set of embeddings based on integrating the one or more knowledge embeddings with the one or more multi-modal embeddings.

Knowledge integration further facilitates the ability of the system to scale to large models by learning semantics such as types/subtypes, rules, processes, and commonsense. Thus, systems configured according to the disclosed embodiments allow for the generation of a more compact and smaller model, reducing the cost for training and implementation, and increases learning efficiency of the model. Other technical benefits include bringing in external information, effective customization, and reducing the model size.

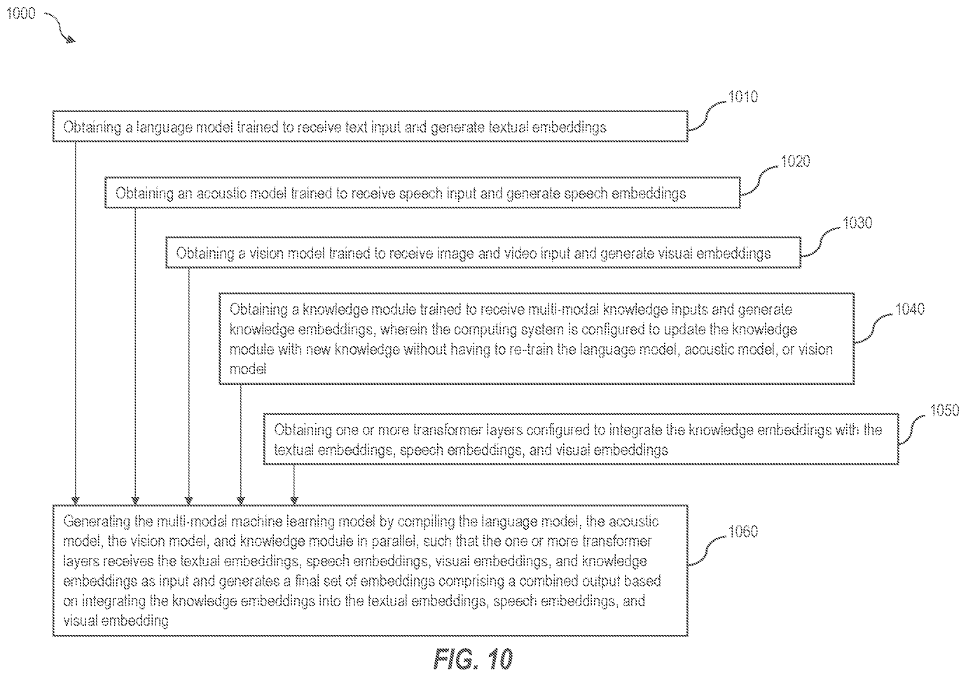

Attention will now be directed to FIG. 10 which illustrates a flow diagram 1000 that includes various acts (act 1010, act 1020, act 1030, act 1040, act 1050, and act 1060) associated with exemplary methods that can be implemented by computing system 110 for generating a multi-modal machine learning model.

The first illustrated act includes an act of obtaining a language model trained to receive text input and generate textual embeddings (act 1010). The systems also obtain an acoustic model trained to receive speech input and generate speech embeddings (act 1020), a vision model trained to receive image and video input and generate visual embeddings (act 1030), and a knowledge module trained to receive multi-modal knowledge inputs and generate knowledge embeddings (act 1040). Such systems are configured to update the knowledge module with new knowledge without having to re-train the language model, acoustic model, or vision model. Additionally, such models are able to process input data from a variety of modalities.

Subsequent to obtaining the language model, the vision model, the speech model, and the knowledge module, the systems obtain one or more transformer layers configured to integrate the knowledge embeddings with the textual embeddings, speech embeddings, and visual embeddings (act 1050). Knowledge integration further facilitates the ability of the system to scale to large models by learning semantics such as types/subtypes, rules, processes, and commonsense. Thus, systems configured according to the disclosed embodiments allow for the generation of a more compact and smaller model, reducing the cost for training and implementation, and increases learning efficiency of the model. Other technical benefits include bringing in external information, effective customization, and reducing the model size.

Finally, the systems generate the multi-modal machine learning model by compiling the language model, the acoustic model, the vision model, and knowledge module in parallel (act 1060). The transformer layers are beneficially configured to receive the textual embeddings, speech embeddings, visual embeddings, and knowledge embeddings as input and generate a final set of embeddings comprising a combined output based on integrating the knowledge embeddings into the textual embeddings, speech embeddings, and visual embeddings.

By configuring a multi-modal model in this manner, several technical benefits are achieved, including an integrative, extensible, composable, and interpretable deep learning model. Models configured according to disclosed embodiments herein beneficially are configured to understand different modalities, achieve functionalities, and give explanations behind the decision-making process of the model, also while being flexible during customization. Multi-modal machine learning models that employ external attention to knowledge provide solutions to the aforementioned problems with conventional deep learning models.

Subsequent to generating the multi-modal machine learning model, the systems are configured to train the multi-modal machine learning model to generate multi-modal embeddings enhanced with knowledge through a variety of training tasks. In some instances, the multi-modal machine learning model is trained according to three sequential tasks. In such configurations, the systems first train the multi-modal machine learning model on a representation learning task without using external knowledge, such that the multi-modal machine learning model is configured to generate the final set of embeddings when no knowledge embeddings are available for integration.

Next, the systems train the multi-modal machine learning model on a representation learning task that utilizes relevant external knowledge such that the multi-modal machine learning model is configured to generate the final set of embeddings when new knowledge embeddings are available for integration. Finally, the systems train the multi-modal machine learning model on a representation learning task that considers irrelevant or noisy external knowledge such that the multi-modal machine learning model is configured to generate a final set of embeddings by ignoring the irrelevant or noisy external knowledge.

For example, utilizing knowledge is more efficient than utilizing raw data, particularly when describing principles and patterns. This in turn provides the technical benefit of reducing the amount of needed training data. Additionally, knowledge is essential for humans to easily extrapolate to out-of-distribution scenarios. Similarly, when knowledge is used to enhance multi-modal embeddings, the model is more easily able to adapt to new domains. Furthermore, the knowledge module is configured to be updated without having to re-train the main model on more data.

After the multi-modal machine learning model is trained according to the aforementioned training regime (or another training protocol described herein), the systems are able to implement the multi-modal machine learning model and generate multi-modal embeddings. For example, the systems apply a new input associated with one or more modalities to the multi-modal machine learning model. The systems then generating a set of embeddings for each of the one or more modalities associated with the new input. After receiving the new input, the systems identify one or more knowledge units that are relevant to the new input and generate one or more knowledge embeddings based on the one or more knowledge units. Finally, the systems generate a final set of embeddings by integrating the one or more knowledge embeddings with the set of embeddings for each of the one or more modalities.

For example, knowledge brings external information which is not available in the task input but is helpful to the model when generating output. Additionally, once a model learns how to retrieve and use knowledge during pre-training, the model is configured to quickly adapt to a new or custom domain with previously unseen knowledge. This adaptation is further improved with a small amount of text, image, and/or speech data associated with the new domain. The amount of new domain data is much less when using knowledge than the amount required to sufficiently customize the entire main model.

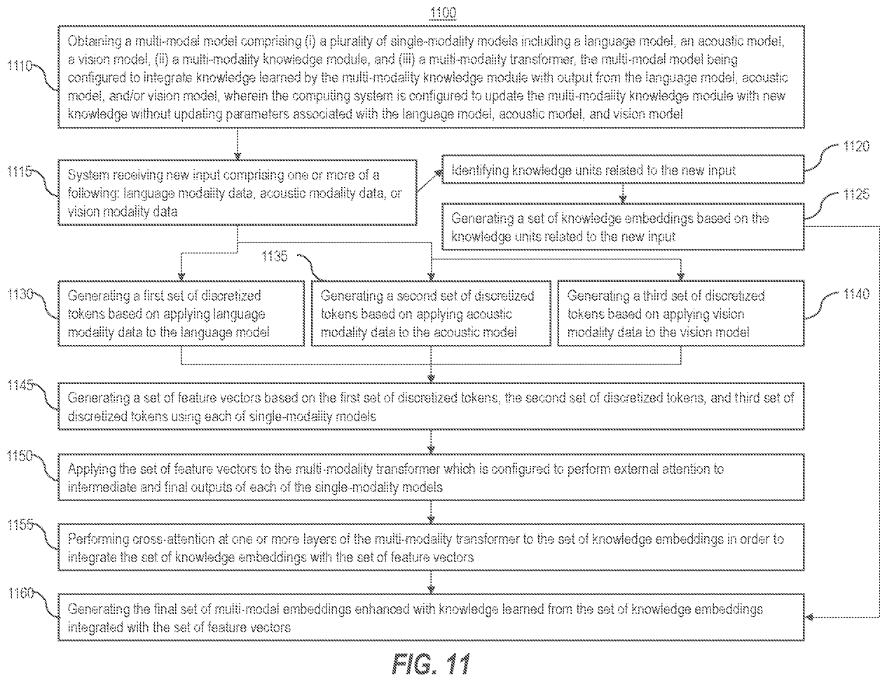

Attention will now be directed to FIG. 11 which illustrates a flow diagram 1100 that includes various acts (act 1110, act 1115, act 1120, act 1125, act 1130, act 1135, act 1140, act 1145, act 1150, act 1155, and act 1160) associated with exemplary methods that can be implemented by computing system 110 for generating a final set of multi-modal embeddings.

The first illustrated act includes an act of obtaining a multi-modal model comprising (i) a plurality of single-modality models including a language model, an acoustic model, a vision model, (ii) a multi-modality knowledge module, and (iii) a multi-modality transformer, the multi-modal model being configured to integrate knowledge learned by the multi-modality knowledge module with output from the language model, acoustic model, and/or vision model (act 1110). Such systems are configured to update the multi-modality knowledge module with new knowledge without updating parameters associated with the language model, acoustic model, and vision model.

After obtaining the multi-modal model, the systems receive new input comprising one or more of a following: language modality data, acoustic modality data, or vision modality data (act 1115). Additionally, the systems identify knowledge units related to the new input (act 1120) and generate a set of knowledge embeddings based on the knowledge units related to the new input (act 1125). The systems then generate a first set of discretized tokens based on applying language modality data to the language model (act 1130), a second set of discretized tokens based on applying acoustic modality data to the acoustic model (act 1135), and a third set of discretized tokens based on applying vision modality data to the vision model (act 1140). The systems also generate a set of feature vectors based on the first set of discretized tokens, the second set of discretized tokens, and third set of discretized tokens using each of single-modality models (act 1145).

After generating the set of feature vectors, the systems apply the set of feature vectors to the multi-modality transformer which is configured to perform external attention to intermediate and final outputs of each of the single-modality models (act 1150). The systems perform cross-attention at one or more layers of the multi-modality transformer to the set of knowledge embeddings in order to integrate the set of knowledge embeddings with the set of feature vectors (act 1155). Finally, the systems generate the final set of multi-modal embeddings enhanced with knowledge learned from the set of knowledge embeddings integrated with the set of feature vectors (act 1160).

In some instances, the systems are configured to dynamically and selectively apply the new input to only those single-modality models that correspond to the modalities identified in the new input. For example, after receiving the new input, the systems identify one or more modalities associated with data included in the new input. Based on identifying the one or more modalities associated with the data, the systems select only those single-modality models that correspond to the one or more modalities associated with the data. Thus, the systems only apply the new input to the single-modality models that correspond to the one or more modalities associated with the data. This reduces latency and computational bandwidth.

In addition to utilizing different single-modality models, the multi-modal machine learning model also utilizes rule-based models to integrate the different embeddings at various stages of implementation. For example, in some instances, the systems are configured to apply a rule-based machine learning model comprising a plurality of input-output prediction rules while integrating the set of knowledge embeddings with the set of feature vectors. The systems then generate one or more sets of predicted multi-modal embeddings by integrating the set of knowledge embeddings with the set of feature vectors according to one or more input-output prediction rules. Each set of predicted multi-modal embeddings corresponds to at least one input-output prediction rule.

With knowledge attention, the intensity of external attention to different knowledge units and logic rules can show how much the model's prediction is dependent on specific concepts and rules. It can also highlight the reasoning path within the knowledge graph, which gives human-readable interpretations, which is an improvement over parameter-based large black-box deep learning models.

Subsequent to generating the one or more sets of predicted multi-modal embeddings, the systems apply a weighting scheme associated with one or more confidence scores for applying each input-output prediction rule. Finally, the systems generate the final set of multi-modal embeddings by combining the one or more sets of predicted multi-modal embeddings according to the weighting scheme.

In some instances, the systems learn from output feedback that a more optimal combination of multi-modal embeddings is achievable by updating/changing the weighting scheme. For example, systems are configured to evaluate the final set of multi-modal embeddings for accuracy and determine to change the weighting scheme based on evaluating the final set of multi-modal embeddings. In response to determining to change the weighting scheme, systems generate a new weighting scheme and apply the new weighting scheme to new inputs received by the computing system. The new inputs are then combined according to the new weighting scheme to generate a new final set of multi-modal embeddings, which are of higher quality than the previous final set of multi-modal embeddings that were generated according to the previous weighting scheme.

Such embodiments are directed to systems and methods that facilitate an improvement in deep learning model's decision-making process, by increasing transparency and interpretability. For example, by integrating human knowledge, logic, rules and code into a multi-modal machine learning model, the system(s) achieve much better interpretability of the models. This is very important in many Cognitive Services applications such as Decision-based services, where various verticals require the AI system to offer explanations for its decisions. Another aspect of achieving interpretability is via causal inference, which provides factual and counterfactual analysis for the output, depicting a full picture of the reasoning behind the decision. The causal inference can also quantitatively determine the importance of each factor, offering useful insights for users to adjust their strategy.

Once the final set of multi-modal embeddings are generated, the final set of multi-modal embeddings are configured to be used in a plurality of downstream applications. In some instances, the final set of multi-modal embeddings are used for meeting summarization. In such instances, the new input to the main model is a transcript of a meeting having one or more speaker participants, wherein the systems are further configured to utilize the final set of multi-modal embeddings to generate a meeting summarization of the transcript, wherein the meeting summarization is enhanced with external information (e.g., knowledge) obtained through the knowledge module.

In some instances, the final set of multi-modal embeddings are used to enhance a particular downstream task, such as meeting summary generation, that corresponds to a new domain. For example, in instances where the new input is associated with a new enterprise domain, the systems are configured to utilize the final set of multi-modal embeddings to predict an answer to a question associated with the new enterprise domain, the answer being learned from obtaining knowledge related to the new enterprise domain from the multi-modality knowledge module.

In some instances, the new input is associated with input obtained from a visual intelligence system. In those instances, the systems are configured to enhance the visual intelligence system with new knowledge such that the visual intelligence system is adaptable to new targets and environments without having to re-train the visual intelligence system.

### Downstream Applications

Within Azure Cognitive Services, there are many business scenarios that produce higher quality deliverables when using a multi-modal machine learning model as described herein. For example, the multi-modal machine learning model is configured for summarization of business content, business Q&A, text analytics, speech and translation, generative conversational AI, reinforcement decision making, and for ambient monitoring.

Regarding business meeting summary generation, business meetings, sales calls, and customer support conversations often have rich context which are essential in understanding its content. The context includes the participants' information, associated documents and slides, related notes, emails, etc. The ability to grasp this external information beyond the transcript is critical to provide relevant and effective meeting recap. Furthermore, a human-written meeting note often has a clear and professional layout, which should be learned by the models via rule and control flow integration.

Regarding business Q&A, enterprise data contains various custom formats and content, including 1) terminologies; 2) databases; 3) unstructured documents. Pre-trained models to deal with plain text can hardly adapt to these custom data quickly and effectively. Thus, the integration of external attention within the framework of the multi-modal model facilitates an improvement in the fine-tuning of the underlying model to understand enterprise data and make predictions. For instance, the language model included in the main model can comprehend the various terms and extract related information from database/corpus to answer user's questions.

Regarding text analytics, custom NLU tasks are closely related to the customer's business context, involving terminologies, contact list, historic corpora. By leveraging knowledge learned through the external attention phase to adopt this contextual information, the accuracy of NER/Intent classification models is significantly improved, especially under the circumstances of training data shortage.

Regarding speech and translation, both speech recognition and translation significantly benefit from a customizable language model to be able to correctly interpret the semantics of the original input from speech and/or source language. For example, with a name list of people related to a speech, wherein external attention is performed to ground information extracted from the name list, pronunciation close to a person's name will be correctly transcribed.

Regarding generative conversational AI, conversation understanding requires both long-range context and external knowledge to generate relevant, diverse, and coherent responses. Disclosed embodiments provide for a conversation history to be summarized and formulated as a dynamic knowledge graph, whereas the external knowledge can be regarded as a static knowledge graph. By integrating the external attention to effectively consume the knowledge from these two graphs, a generative conversation model is greatly improved.

In a reinforcement learning-based decision-making system, the policy network is normally learned in a simulation environment and has a limited generalization ability when applying to a real environment. In addition to further reducing the domain gap between the simulation and real environments, integrating knowledge via external attention as disclosed herein in both the training stage and the inference stage effectively improves the robustness of the learned internal state representations and thus lead to better generalization.

Ambient monitoring refers to a visual intelligence system that is context aware, personalized, and adaptive to target persons or environments. Pre-trained vision models can only recognize a limited number of objects and human actions. Introducing knowledge using external attention without finetuning greatly improves the generalization ability of the pre-trained model. In particular, multimodal aligned knowledge representation will make the system capable of adapting to new tasks or environments based on language description and thus achieving zero-shot generalization.

In view of the foregoing, it will be appreciated that the disclosed embodiments provide many technical benefits over conventional systems and methods for generating and updating a knowledge module, for generating and training a multi-modal machine learning model, and for generating multi-modal embeddings enhanced with knowledge. The disclosed embodiments beneficially improve conventional techniques for leverage knowledge information as part of a multi-modal model's training and run-time implementation for generating knowledge enhanced multi-modal embeddings.

### Example Computing Systems

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., hardware storage device(s) 140 of FIG. 1) that store computer-executable instructions (e.g., computer-executable instructions 118 of FIG. 1) are physical hardware storage media/devices that exclude transmission media. Computer-readable media that carry computer-executable instructions or computer-readable instructions (e.g., computer-executable instructions 118) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method implemented by a computing system for building a multi-modal machine learning model, the method comprising:
the computing system obtaining a language model trained to receive text input and generate textual embeddings;
the computing system obtaining an acoustic model trained to receive speech input and generate speech embeddings;
the computing system obtaining a vision model trained to receive image and video input and generate visual embeddings;
the computing system obtaining a knowledge module trained to receive multi-modal knowledge inputs and generate knowledge embeddings, wherein the computing system is configured to update the knowledge module with new knowledge without having to re-train the language model, acoustic model, or vision model;
the computing system obtaining one or more transformer layers configured to integrate the knowledge embeddings with the textual embeddings, speech embeddings, and visual embeddings; and
the computing system generating the multi-modal machine learning model by compiling the language model, the acoustic model, the vision model, and knowledge module in parallel, such that the one or more transformer layers receives the textual embeddings, speech embeddings, visual embeddings, and knowledge embeddings as input and generates a final set of embeddings comprising a combined output based on integrating the knowledge embeddings into the textual embeddings, speech embeddings, and visual embeddings.

2. The method of claim 1, further comprising:
training the multi-modal machine learning model on a representation learning task without using external knowledge, such that the multi-modal machine learning model is configured to generate the final set of embeddings when no knowledge embeddings are available for integration.

3. The method of claim 1, further comprising:
training the multi-modal machine learning model on a representation learning task that utilizes relevant external knowledge such that the multi-modal machine learning model is configured to generate the final set of embeddings when new knowledge embeddings are available for integration.

4. The method of claim 1, further comprising:
training the multi-modal machine learning model on a representation learning task that considers irrelevant or noisy external knowledge such that the multi-modal machine learning model is configured to generate a final set of embeddings by ignoring the irrelevant or noisy external knowledge.

5. The method of claim 1, further comprising:
the computing system applying a new input associated with one or more modalities to the multi-modal machine learning model;
the computing system generating a set of embeddings for each of the one or more modalities associated with the new input;
the computing system identifying one or more knowledge units that are relevant to the new input;
the computing system generating one or more knowledge embeddings based on the one or more knowledge units; and
the computing system generating a final set of embeddings by integrating the one or more knowledge embeddings with the set of embeddings for each of the one or more modalities.

6. A method implemented by a computing system for generating a final set of multi-modal embeddings enhanced with knowledge, the method comprising:
the computing system obtaining a multi-modal model comprising (i) a plurality of single-modality models including a language model, an acoustic model, a vision model, (ii) a multi-modality knowledge module, and (iii) a multi-modality transformer, the multi-modal model being configured to integrate knowledge learned by the multi-modality knowledge module with output from the language model, acoustic model, and/or vision model, wherein the computing system is configured to update the multi-modality knowledge module with new knowledge without updating parameters associated with the language model, acoustic model, and vision model;
the computing system receiving new input comprising one or more of a following: language modality data, acoustic modality data, or vision modality data;
the computing system generating a first set of discretized tokens based on applying language modality data to the language model;
the computing system generating a second set of discretized tokens based on applying acoustic modality data to the acoustic model;
the computing system generating a third set of discretized tokens based on applying vision modality data to the vision model;
the computing system generating a set of feature vectors based on the first set of discretized tokens, the second set of discretized tokens, and third set of discretized tokens using each of single-modality models;
the computing system applying the set of feature vectors to the multi-modality transformer which is configured to perform external attention to intermediate and final outputs of each of the single-modality models;
the computing system identifying knowledge units related to the new input;
the computing system generating a set of knowledge embeddings based on the knowledge units related to the new input;
the computing system performing cross-attention at one or more layers of the multi-modality transformer to the set of knowledge embeddings in order to integrate the set of knowledge embeddings with the set of feature vectors; and
the computing system generating the final set of multi-modal embeddings enhanced with knowledge learned from the set of knowledge embeddings integrated with the set of feature vectors.

7. The method of claim 6, further comprising:
after receiving the new input, the computing system identifying one or more modalities associated with data included in the new input; and
based on identifying the one or more modalities associated with the data, the computing system selecting only those single-modality models that correspond to the one or more modalities associated with the data, wherein the computing system only applies the new input to the single-modality models that correspond to the one or more modalities associated with the data.

8. The method of claim 6, further comprising:
the computing system applying a rule-based machine learning model comprising a plurality of input-output prediction rules while integrating the set of knowledge embeddings with the set of feature vectors;
the computing system generating one or more sets of predicted multi-modal embeddings by integrating the set of knowledge embeddings with the set of feature vectors according to one or more input-output prediction rules, each set corresponding to at least one input-output prediction rule;
the computing system applying a weighting scheme associated with one or more confidence scores for applying each input-output prediction rule; and
the computing system generating the final set of multi-modal embeddings by combining the one or more sets of predicted multi-modal embeddings according to the weighting scheme.

9. The method of claim 8, further comprising:
the computing system evaluating the final set of multi-modal embeddings for accuracy;
determining to change the weighting scheme based on evaluating the final set of multi-modal embeddings;
in response to determining to change the weighting scheme, the computing system generating a new weighting scheme; and
the computing system applying the new weighting scheme to new inputs received by the computing system.

10. The method of claim 6, wherein the new input is a transcript of a meeting having one or more speaker participants, the method further comprising:
the computing system utilizing the final set of multi-modal embeddings to generate a meeting summarization of the transcript, wherein the meeting summarization is enhanced with knowledge obtained through the knowledge module.

11. The method of claim 6, wherein the new input is associated with a new enterprise domain, the method comprising:
the computing system utilizing the final set of multi-modal embeddings to predict an answer to a question associated with the new enterprise domain, the answer being learned from obtaining knowledge related to the new enterprise domain from the multi-modality knowledge module.

12. The method of claim 6, wherein the new input is associated with input obtained from a visual intelligence system, the method comprising:
the computing system enhancing the visual intelligence system with new knowledge such that the visual intelligence system is adaptable to new targets and environments without having to re-train the visual intelligence system.

13. A method implemented by a computing system for updating a knowledge module, the method comprising:
the computing system obtaining a knowledge module configured to receive one or more knowledge inputs corresponding to one or more different modalities and generate a set of knowledge embeddings to be integrated with a set of multi-modal embeddings generated by a multi-modal main model;
the computing system receiving a knowledge input at the knowledge module;
the computing system identifying a knowledge type associated with the knowledge input;
the computing system extracting at least one knowledge unit from the knowledge input, the at least one knowledge unit corresponding to the knowledge type;
the computing system selecting a representation model that corresponds to the knowledge type for representing the at least one knowledge unit;
the computing system selecting a grounding type configured to ground the at least one knowledge unit into the representation model; and
the computing system grounding the at least one knowledge unit into the representation model according to the grounding type, wherein the knowledge module is dynamically updated with new knowledge comprising the at least one knowledge unit represented in the representation model and based on the knowledge input such that the multi-modal main model is able to learn new knowledge without having to update one or more parameters of the multi-modal main model.

14. The method of claim 13, wherein the knowledge type is identified from one or more of a following knowledge types: knowledge graph, knowledge base, unstructured text, dictionary, data, rule, image, or sound.

15. The method of claim 13, wherein the at least one knowledge unit is identified from one or more of a following knowledge units: entity node, entity-relation tuple, sentences/paragraphs, words, data instance, a piece of rule, object, or pronunciation of phrase.

16. The method of claim 13, wherein the grounding type is selected from one or more of a following knowledge units: entity linking, retrieval, pattern matching, object detection, or similarity search.

17. The method of claim 13, wherein the representation model is selected from one or more of a following representation models: graph neural network, natural language understanding model, inference model, vision model, or acoustic model.

18. The method of claim 17, wherein the knowledge module comprises at least one representation model configured to generate knowledge embeddings from speech-based knowledge inputs, at least one representation model configured to knowledge embeddings from visual-based knowledge inputs, and at least one representation model configured to generate knowledge embeddings from text-based knowledge inputs.

19. The method of claim 13, further comprising:
the computing system generating one or more knowledge embeddings based on applying the knowledge input to the representation model, wherein the representation model is configured to convert the at least one knowledge unit into at least one knowledge embedding.

20. The method of claim 13, further comprising:
the computing system integrating the one or more knowledge embeddings with one or more multi-modal embeddings obtained from the multi-modal main model; and
generating a final set of embeddings based on integrating the one or more knowledge embeddings with the one or more multi-modal embeddings.
